(19) United States
(12) Patent Application Publication
(10) Pub. No.: US 2002/0180909 A1
(43) Pub. Date: Dec. 5, 2002

(54) Device having reflective and transmissive properties

(76) Inventors: Neil D. Lubart, Austin, TX (US); Andrew P. Laurence, Medina, OH (US); Timothy J. Wojciechowski, Westlake, OH (US)

Correspondence Address: BENESCH, FRIEDLANDER, COPLAN & ARONOFF LLP, ATTN: IP DEPARTMENT DOCKET CLERK, 2300 BP TOWER, 200 PUBLIC SQUARE, CLEVELAND, OH, 44114, US

(21) Appl. No.: 10/108,296

(22) Filed: Mar. 26, 2002

Related U.S. Application Data
(60) Provisional application No. 60/278,921, filed on Mar. 26, 2001.
(60) Provisional application No. 60/334,661, filed on Nov. 30, 2001.

(51) Int. Cl. G02F 1/1335

(52) U.S. Cl. 349/113

(57) ABSTRACT

A device having transmissive and reflective properties comprising: a transparent material having a first surface and an opposed, second surface wherein the transparent material permits light arriving from a first direction to enter the first surface, transmit through the transparent material, and exit the second surface; and means for reflecting light arriving from a second direction wherein the second direction being opposite the first direction, wherein the sum of the percentage of light being transmitted relative to the amount of light coming from the first direction and the percentage of light being reflected relative to the amount of light coming from the second direction, is greater than 100 percent.

### CROSS-REFERENCE TO RELATED APPLICATIONS

This application claims the benefit of priority of U.S. Provisional Application No. 60/278,921 filed on Mar. 26, 2001, and U.S. Provisional Application No. 60/334,661 filed on Nov. 30, 2001.

### BACKGROUND-FIELD OF INVENTION

This invention relates to all applications where there is a requirement in which reflectivity of incident light (visible through infrared) in one direction and transmissivity in the opposite direction are simultaneously enhanced. That is, the sum of the reflectivity of light from one side and the transmissivity of light from the other side exceeds 1.0.

One application of the present invention is solar collection devices in which transmission of light would be maximized (reflectivity minimized) in the direction facing the sun and reflectivity maximized (transmissivity minimized) in the direction facing the collector. The invention will significantly increase the level of retained energy and increase the efficiency in such devices. Additionally, the invention could be used as part of a heating, cooling and/or power generation system in which solar energy is utilized for some or all of the power generation, thus reducing the use of fossil fuels.

A second application of the present invention includes using the device according to the present invention with any non-emissive display technology—such as electrochromic, ferroelectric, ferromagnetic, electromagnetic, and liquid crystal—where it is desired to use both externally generated light (ambient) and internally generated light (artificial) such as a backlight system. The device is a replacement for the transflective/reflective/transmissive element of the non-emissive displays, where the replaced element is either independent of or integral to the internally generated light (backlight system). Use of this device will allow brightness contributions simultaneously from artificial light and ambient light such that systems will see a significant decrease in power usage. In systems where a battery is used for some or all of the power supply, battery life can be increased by as much as 174%.

A third application of the present invention is building materials in which a device according to a present invention can be used to direct light from a light source (such as a window or skylight) while at the same time reflecting ambient light within a building or structure.

### BACKGROUND-DESCRIPTION OF PRIOR ART

Solar Collectors

The prior art for solar collectors includes photovoltaics where sunlight is converted directly to electricity, solar thermal energy used to heat water, and large-scale solar thermal power plants used to generate electricity. In these systems solar energy is “collected” by placing panels or arrays of panels in the direct path of the sun. These panels are composed of mirrors or mirror-like material to reflect solar energy to a specific point for collection, or are made up of a variety of absorbent materials. Systems where absorbent materials are used can further be divided into systems where solar energy is collected in cells or where solar energy is absorbed as thermal energy to heat either water or a heat-transfer fluid, such as a water-glycol antifreeze mixture. Most commercially available solar cells are made from wafers of very pure monocrystalline or polycrystalline silicon. Such solar cells, typically, can attain efficiencies of up to 18% in commercial manufacture. The silicon wafers used to make them are relatively expensive, making up 20-40% of the final module cost. The alternative to these “bulk silicon” technologies is to deposit a thin layer of silicon onto a supporting material such as glass. Various materials can be used such as cadmium telluride, copper-indium-diselenide and silicon. There are basically three types of thermal collectors: flat-plate, evacuated-tube, and concentrating. A flat-plate collector, the most common type, is an insulated, weatherproofed box containing a dark absorber plate under one or more transparent or translucent covers. Evacuated-tube collectors are made up of rows of parallel, transparent glass tubes. Each tube consists of a glass outer tube and an inner tube, or absorber, covered with a selective coating that absorbs solar energy well but inhibits radiative heat loss. The air is withdrawn (“evacuated”) from the space between the tubes to form a vacuum, which eliminates conductive and convective heat loss. Concentrating collector applications are usually parabolic troughs that use mirrored surfaces to concentrate the sun's energy on an absorber tube (called a receiver) containing a heat-transfer fluid.

Emissive Displays

The prior art for non-emissive displays, particularly liquid crystal displays, include either reflective displays or surface light source (transmissive) displays, commonly denoted backlit displays. The conventional reflective display which uses a reflective film as the bottom layer to redirect ambient light back through the display elements has a composition as illustrated in FIG. 101. In this drawing ambient light 10 (sunlight, artificial light—such as office lighting—or from a light source 11 attached to the top of the unit) enters the display unit, passes through the various layers of the unit, 6 polarizers, 7 glass plates (which may include color filters, common electrodes, TFT matrix, or other components), and 8 liquid crystal suspension, and is redirected from the reflective film 9 back through the various layers to produce an image. This method of creating an image with available ambient light is limited by the available light. This method is not an effective means for producing high quality graphic images and severely limits the quality of color images in a variety of conditions. The conventional backlight (transmissive) display has a composition as illustrated in FIG. 2. In this drawing, light is produced with a backlight assembly 12 and directed as light ray 13, through the various layers, such as 6 polarizers, 7 glass plates (which may include color filters, common electrodes, TFT matrix, or other components), and 8 liquid crystal suspension, to produce an image. This method of producing an image with artificial light is limited by the amount of ambient light and, in systems where a battery is used some or all of the time to generate power, by limited battery life. When ambient light is present, glare is created by light reflecting off the various layers, as described above, without passing through all the layers 6 through 8. To overcome this glare and to produce an image that is palatable to a user, the backlight gain must be increased to produce more usable light, i.e. more light passing through layers 6 through 8. This increase in artificial light causes an added drain on the battery and thus reduces the usability of the system to which the display is attached. As ambient light increases, glare increases and thus, at some point the backlight becomes ineffective in producing a palatable image.

Previous attempts to use simultaneously the ambient light and a backlight have resulted in applications that compromise both the transmissive qualities and the reflective qualities of the display. Hochstrate, in U.S. Pat. No. 4,196,973 discloses the use of a transflector for this purpose. Weber, in U.S. Pat. No. 5,686,979, col. 2, discloses the limitations of the transflector for this purpose and alternatively proposes a switchable window that at one time is wholly transmissive and at another time is wholly reflective.

Building Materials

The prior art for building materials is related to films or coatings for light sources (such as windows, skylights, or light pipes) in which the control of transmittance and/or reflection of light is desired. Films or coatings generally fall within two categories: tinting or reflecting materials. Tinting materials have the quality of reflecting a certain percentage of light from one side of the film while transmitting the remainder of the light. In tinting films or coatings, the ratio of transmittance/reflectance is determined by the properties of the material(s), and is the same on either side of the film (Reflectivity (R)+Transmissivity (T)=1). For reflective films or coatings, the reflectivity (R) is less than or equal to 1, where the limit is determined by the properties of the material.

### BRIEF DESCRIPTION OF THE DRAWINGS

These and other features, aspects, and advantages of the present invention will become better understood with regard to the following description, appended claims, and accompanying drawings where:

FIG. 1 (prior art) is a diagram showing the operation of a conventional reflective display;

FIG. 2 (prior art) is a diagram showing the operation of a conventional backlight display;

FIG. 3 is a diagram illustrating a cross-section of a device according to the present invention;

FIG. 4 is a diagram showing the general features of a backlight embodiment of the present invention;

FIG. 5 is a diagram showing the general features of a solar panel embodiment of the present invention;

FIG. 6 is a diagram showing the typical composition of a non-emissive display utilizing the present invention;

FIG. 7 is a diagram showing the operation of an embodiment of the present invention utilizing a collimator;

FIG. 8 is a diagram showing a cross-section of an embodiment of the present invention and the associated light paths;

FIG. 9 is a diagram showing a cross-section of an embodiment of the present invention where the bases of the triangular structures are separated from the device;

FIG. 10 is a diagram showing the typical composition of a non-emissive display utilizing the present invention where the reflective surface faces the backlight assembly;

FIG. 11 is a diagram showing the typical composition of a non-emissive display utilizing the present invention along with raised reflective structures where the reflective surface faces the backlight assembly;

FIG. 12 is a diagram showing the typical composition of a non-emissive display utilizing the present invention along with raised reflective structures on both the reflective and transmissive surfaces where the reflective surface faces the backlight assembly;

FIG. 13 is a diagram showing the typical composition of a non-emissive display utilizing the present invention along with raised reflective structures on both the reflective and transmissive surfaces where the reflective surface faces the liquid crystal module;

FIG. 14 is a diagram showing the typical composition of a non-emissive display utilizing the present invention along with lens lets for collimating light where the lens lets are positioned between the backlight assembly and the device according to the present invention;

FIG. 15 is a diagram showing the typical composition of a non-emissive display utilizing the present invention along with lens lets for collimating light where the lens lets are positioned below the backlight assembly;

FIG. 16 illustrates a first process for making the device according to the present invention by forming the desired structures in a photosensitive film; and

FIG. 17 illustrates a second process for making the device according to the present invention by forming the desired structures in a photosensitive film

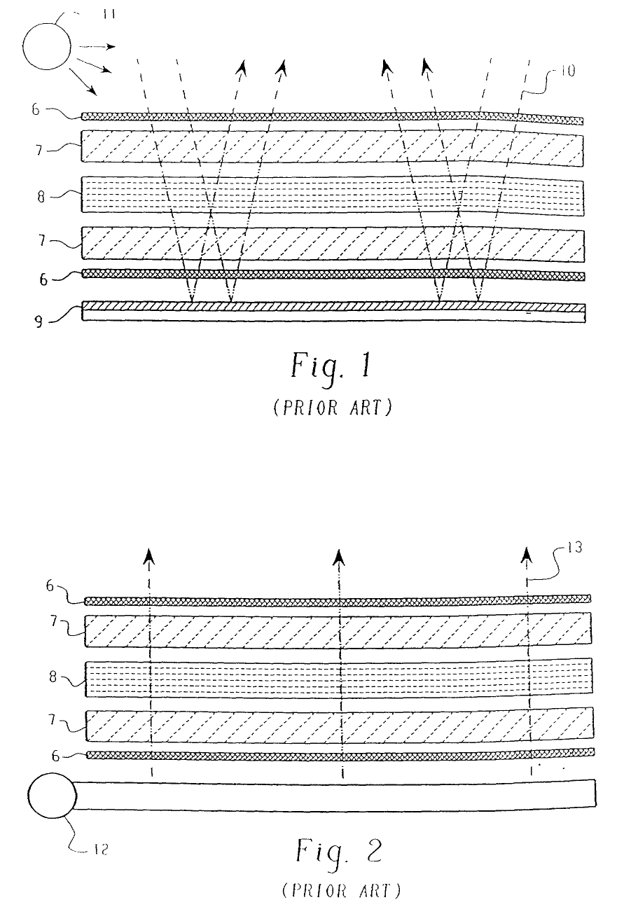

### REFERENCE NUMERALS IN FIGS. 1-9

6 polarizers

7 glass plates

8 liquid crystal suspension

9 reflective film

10 ambient light from sun or room

10A light ray striking absorber directly

10B light ray strikes absorber directly, is reflected off absorber, is reflected off base of reflective structure back to absorber, etc.

10C light ray strikes side of reflective structure and is directed to absorber, reflected off absorber, reflected by base of reflective structure back to absorber, etc.

11 controllable source of light from exterior of display

12 backlight assembly

13 light ray from backlight assembly

14 transparent material of the device

15 reflective material of the device

16 remainder of the non-emissive display system

17 base of the reflective structure

18 spacing between reflective structures at the base

19 thickness of the device

20 height of the reflecting structure from base to apex

21 the number of reflecting structures per pixel (picture element of display)

22 cross-section of the device

23 the sun

24 absorbing material in a solar collector

31 transparent material

32 reflective/refractive shapes

33 a reflective material

34 collimator

35 light ray

36 light ray

37 light ray

41 boundary edge of the element

42 body of the element

43 structures

44 light ray

45 light ray

46 light ray

47 light ray

48 light ray

49 light ray

### DETAILED DESCRIPTION OF THE INVENTION

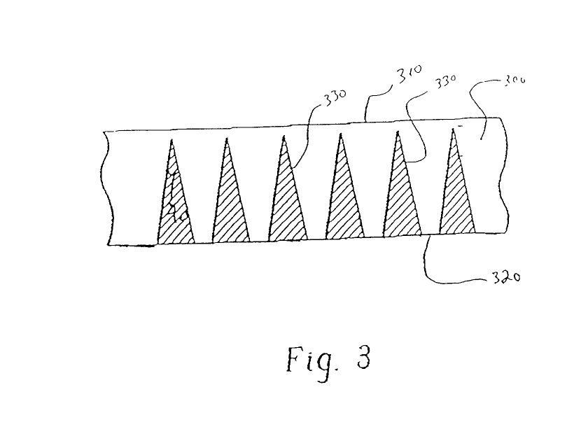

Referring now to the drawings where the illustrations are for the purpose of describing the preferred embodiment of the present invention and are not intended to limit the invention described herein, FIG. 3 illustrates a cross-section of a device according to the present invention. A device having reflective and transmissive properties comprises (i) means for transmitting light arriving from a first direction and emanating from a first, independent source; and (ii) means for reflecting light arriving from a second direction, said second direction being opposite said first direction, and emanating from a second, independent source, wherein the sum of the percentage of light being transmitted relative to the amount of light coming from said first direction and the percentage of light being reflected relative to the amount of light coming from said second direction, is greater than 100 percent.

In operation, the device of the present invention is capable of achieving high reflectivity and low transmissivity through the film in one direction and high transmissivity and low reflectivity in the other direction.

R₁=reflectivity from one side

T₁=transmissivity from one side

A₁=absorptivity from one side

R₂=reflectivity from the other side

T₂=transmissivity from the other side

A₂=absorptive from the other side

From the conservation of energy: R₁+T₁+A₁=1 and R₂+T₂+A₂=1 In the prior art of transflectors, R=R₁=R₂; T=T₁=T₂; and A=A₁=A₂. It follows that in the prior designs, R+T=1 when A=0. Even where prior art claims to overcome the limit of transflectors and where the disclosed transflector is meant to channel or direct light, no overall transmittance or reflectance is shown so that any possible gain cannot be determined and is not apparent.

In this art, the value of the reflectance on one side of the film is significantly decoupled from the value of the reflectance on the other side, and the value of the transmissivity on one side is significantly decoupled from the value of the transmissivity on the other side. This newly disclosed film allows R₁≠R₂, T₁≠T₂, and A₁≠A₂. A specific embodiment will be shown below in which T₁, R₂, A₁, and A₂ are small. It follows that R₁+T₂>1. This disclosed film multiplies the transflecting effect. In the theoretical limit, for this non-emissive version of the film, T₁=R₂=A₁=A₂=0. Then R₁+T₂=2.

As used herein, the device having reflective and transmissive properties is capable of transmitting and reflecting light (hereinafter referred to as “device”). The present invention has the unique ability to reflect and transmit more light than any prior art device. The sum of the percent of light capable of being reflected, plus the sum of light capable of being transmitted, will be greater than 100 percent.

The transmitting means comprises a transparent film material 300 having a first surface 310 and an opposing second surface 320. The reflecting means comprises a plurality of reflective structures 330 positioned within the transparent film material 300. For purposes of the present application, the terms “reflective or reflection”, when discussing light striking the body of the structure, also include “refractive or refraction” where the difference in the index of refraction of the materials, along with the angle of incidence, results in substantial or near total reflection of the light striking the structure.

As used in this application, the term “structure” refers to the shape of the element refracting or reflecting light. The structure may be a physically separate item mounted on or in the light transmissive material, it may be formed or represent a groove or indentation that has been cut into the light transmitting material, or it may be the end result of treatment of portions of the light transmissive material such that a shape having a different index of refraction is formed. Where the transmissive material is a gas or vacuum, as may be found in solar applications, the structure is mounted “in” the material by means of a grid, wire, filament or other such device, with the grid representing a surface of the transflector.

The device according to the present invention can be placed in conjunction with other elements to produce additional effects. In the preferred embodiment, a collimating element may be integrated with the device to form a single element, attached to the device, or incorporated into another component of a system to which the device is attached, such that the collimating element is proximal to the transmitting side of the device and between the element and the transmissive light source. The collimating element accepts incoming energy waves distributed over a broad angle and redirects the energy waves to emerge at an angle less than some specified angle as measured from the normal to the surface of the device. The use of a collimating element ensures that virtually all energy entering the device from the transmissive surface will be constrained within an arc of about 10° of perpendicular to the plane of the element. Constraining transmitted energy in this manner will improve the performance of the device, but is not a requirement for the device to produce beneficial effects. One skilled in the art will recognize that the collimating element may be any light transmissive material with an index of reflection lower than that of the transmissive material of the device.

The determining factors for configuring the device are the aspect ratio of the reflecting/refracting structures, spacing between structures, and materials used to construct the device. These factors determine (1) the allowable incident angle of the energy entering the device from one direction (transmissive), (2) the proportion of energy transmitted from that direction, (3) the proportion of energy reflected by the opposite side of the device, (4) the distribution of energy emerging from the element, (5) the percentage of energy lost to internal absorption or scattering. Aspect ratio (the ratio of height to base) of the reflecting/refracting structures determines the relationship between the specific angle at which the transmitted energy enters the device and the angle at which the transmitted energy emerges from the device. The spacing between the structures determines the proportion of energy reflected by the device (from the reflective side) and the distribution of transmitted energy (from the transmissive side). By increasing the spacing between the structures, a smaller proportion of energy is redirected from the transmissive side while reflection of energy from the opposite direction is reduced. Conversely, by decreasing the spacing between the structures, a greater proportion of the transmitted energy will be redirected while a larger proportion of the energy from the opposite direction will be reflected.

The cross-section of the reflective structures may assume the shape of any polygon which may be arranged in a variety of patterns. Preferably, the cross-section of the reflective structure is a triangle where the base of the triangle is situated adjacent to the second surface and the apex (i.e., tip) of the triangle is situated closer to the first surface of the transparent film material. The structures may be replaced by a series of discrete objects such as pyramids, cones, or any polyhedron, and likewise may be arranged in a variety of patterns or randomly. The structures, or discrete objects, may be repeated in parallel and spaced across the area of the transparent film material. Preferably, the structures are arranged in triangular cross-sectional rows within the transparent film material. The structures, or discrete objects, may be arranged in varying shapes, heights, angles, or spacing before a pattern is repeated. Furthermore, the aspect ratio (i.e., height-to-base ratio) and shape of the structures or discrete objects may vary periodically. By periodic, it is meant that structures eventually repeat. For example, in the case where there are three structures, first consider structure one and structure two. The structures may have different aspect ratios or shapes and be different distances from the surface of the device. In addition, the distance between structures one and two may not be the same as between structures two and three. However, structures four, five and six repeat the distribution of structures one, two and three. Thus, eventually, the structures repeat and there is long-range order or periodicity. Varying the size, shape, and distance between structures may be used to eliminate diffraction patterns due to its ability to disrupt short-range periodicity. Varying the size, shape, and distance between structures may also eliminate diffraction patterns from causing distortions in larger displays greater than five inches in diagonal.

In the preferred embodiment, the cross-section of a single structure is triangular and extends from one edge of the transparent film material to the opposite edge to form a single row and is oriented in the transparent film material (body of the element) such that the base of the triangle is parallel to and coincident with the plane of one surface of the body of the device (i.e., the reflective surface) where the opposite surface as identified as the “transmissive surface.” However, the base and/or apex of the structure (e.g., triangular cross-section) may be recessed from the plane of the surface of the body of the device such that the structure is embedded within the transparent film material. The embedded structure may be constructed the following ways: i) a solid reflective material structure made of metal or another reflective material; ii) a polymer structure (having a lower index of refraction than the transparent film material) coated with a reflective material at the base of the structure; and iii) a solid polymer structure (having a lower index of refraction than the transparent film material) and a reflective layer separated from the solid polymer structure yet still embedded within the transparent film material. In the preferred embodiment, the triangular row is repeated in parallel and evenly spaced across the entire area of the element forming a striped pattern of structures and spaces. In other embodiments the triangular-shaped rows may be replaced by discrete objects such as pyramids, cones, or any polyhedron, and likewise may be arranged in a variety of patterns to achieve specific effects. In other embodiments, the discrete shapes, as described above, may be arranged in varying shapes, heights, angles, or spacing.

The discrete faces of the structures or objects may be planar, concave, convex, or pitted such that light reflecting from any face may be controlled. Preferably, the discrete faces of each triangular row are planar. In other embodiments, one or more of the discrete faces of the row, or discrete shapes, may be concave, convex, and/or pitted. Additionally, micro-structures (e.g., pyramids or cones) may be deposited on the flattened base of each structure to further control the direction of reflected energy and to focus the diffused ambient energy in a forward direction, increasing the effective reflectivity. Also, a non-flat surface on the base of the reflecting material (e.g., concave dimples) can reduce specular reflections. Preferably, the height of the dimples is between about 0.1μ and 1μ (μ=micron). Additionally, the discrete face of the base of a triangular cross-sectional structure may have different features than the other faces of that very same structure. These features may include planar, concave, convex, pitted, or dimpled surfaces. Furthermore, the discrete faces of each structure may converge to form either a sharp point or a radius of curvature. A radius of curvature applied on the structure's reflective coating will eliminate sharp edges. Such edges may create unwanted diffraction effects in this application. A radius applied to the edges of the exterior reflective surface adjacent to the window opening can be used to minimize or eliminate such diffraction effects.

Preferably, the cross-section of the structures is triangular shaped each having a base, a height, and a pair of sidewalls. Each sidewall (i.e., face) is at an angle relative to the base. Furthermore, the base is preferably associated with the reflective layer. The angle may be between about 83 degrees and less than 90 degrees. If collimating film is used in conjunction with the device according to the present invention, then the angle may be between about 76 degrees and less than 90 degrees. Preferably, the width of the base may be between about 2μ and 200μ. The structures may have a height-to-base aspect ratio of between about 4 and about 22. If collimating film is used in conjunction with a device according to the present invention, then a height-to-base aspect ratio of 2 may be possible. Preferably, the height-to-base aspect ratio of the triangular cross-section structures is between about 6 and about 22. The base of each structure may be separated by a distance between about 1μ and about 100μ.

The transparent film material should be highly optically transmissive to visible, ultraviolet, and/or near infrared light between about 300-2,500 nanometers, stable to ultraviolet light, impervious to moisture, non-hygroscopic, scratch resistant, and easy to keep clean, with an appropriately chosen refractive index to match the other elements of the system in which it is a part. Preferably, the transparent film material will have specific properties that minimize absorption and redirection of energy—such as internal scattering. If an adhesive is used to secure the device in an application, the adhesive should be highly optically transmissive to light between about 300-2,500 nanometers and stable to ultraviolet light.

The general relationship between the aspect ratio of height to base for the reflecting/refracting structures and the spacing between structures is illustrated in the following examples:

### EXAMPLE 1

A single structure is triangular in cross section and extends along the full length of the device from one side to the other. The above structure is repeated at regular intervals such that one side of the entire body of the device is covered with the bases of alternating triangular rows and spaces in-between. If the specific application requirement for the device calls for approximately 66.6% of the energy from one side (the reflecting side) is to be reflected and the transmitted energy from the opposite side is restricted to emerge about 5°, than the aspect ratio must be a minimum of 11.5:1. The spacing between the structures in this example will be approximately half the dimension of the base of a structure. In this example, the sum of potentially useful reflected energy from one side R plus the sum of potentially useful transmitted energy from the opposite side T is approximately 1.66 (R+T=1.66). This can be restated as 66.6% of the energy entering the device from the reflective side is reflected and 100% of energy entering the element from the transmissive side is transmitted (R=66.6% and T=100% so that R+T=166%).

### EXAMPLE 2

Assume that the structures are the same as in example 1 and that the specific application requirements call for maximizing the amount of transmitted energy independent of any specific angle of emergence. Also assume that the energy entering the element from the transmissive side is uniformly collimated within about 10° of perpendicular to the plane of the device.

In this application the requirements are for reflection of about 80% of the energy in one direction (the reflecting side) and for transmission of more than 95% of the energy from the opposite side (the transmitting side). A device with an aspect ratio of 15:1 will be approximately 96.8% transmissive, assuming a perfectly reflecting material for the structures. The spacing between the structures is about one-fourth the dimension of the shaped structures. In this example the sum of potentially useful reflected energy from one side R plus the sum of potentially useful transmitted energy from the opposite side T is approximately 1.77 (R+T=1.77).

Additionally, the device according to the present invention can be configured to specifically control the distribution of both reflected and transmitted energy. As an example, such a configuration may be useful in a display application to improve viewing angle.

A light ray striking a triangular row of structures near the tip will have the most number of redirections before possibly exiting the element. By using basic geometry and a rudimentary understanding of geometric optics, one skilled in the art can calculate what aspect ratio and width between structures is necessary to preferably redirect light striking near the tip no more than twice before exiting. A geometric plot of the light ray path can be used to derive the relationships between the various parameters, including the constraints of the system. The height of the structure will be determined by several factors, among which is the thickness of the transparent material. If the requirement of a specific application is to transmit light through the transflector within 10 degrees of perpendicular, then assuming a height, one can plot or calculate the apex angle. The apex angle and the height will give the aspect ratio and thus the width of the base of the structure.

There are at least three methods of manufacturing the device according to the present invention. First, the device can be manufactured utilizing a mechanical process such as embossing or molding or a chemical process such as etching. Utilizing either of these processes, the structures may be formed in the body of the transparent film material by creating indentations (voids) in the transparent film material. These indentations may then be filled with either a reflective material or a material that has a lower index of refraction than that of the transparent film material. The indentations in the transparent film material may be embedded in the transparent film material such that the base of each shape is approximately parallel to and coincident with, or slightly recessed from, the transparent material.

To accommodate either of these processes, the transparent film material requires specific properties necessary for etching, molding, embossing, or other processes that alter the body of the device. Examples of suitable materials are polymers such as polycarbonate and PMMA (polymethylmethacrylate). The preferred reflective material for filling the indentations is a metal composite or other material with a high reflectivity such as aluminum, gold, silver, nickel, chrome, a dielectric or other metallic alloy with a reflectivity of 80% or greater. Preferably, the reflectivity of the material is 95% or greater. The fill material for the reflective structures will be optimized to minimize absorption and have highly reflective properties for the controlled redirection of energy. Where the indentations are filled with a reflective material, a single material, or composite material, may be used to create the above mentioned triangular cross-sectional rows. The preferred material that has a lower index of refraction than that of the transparent film material may be a clear composite paste, composite material (e.g., polymer), or multiple composite materials with different refractive indices or reflective qualities. Additionally, no material (e.g., gas, air, or vacuum) may be used to fill the indentations. The minimum difference in index of refraction between the fill and the body of the element is estimated to be 0.01. Preferably, indices of refraction are the same for each shape across the body of the device. Furthermore, if the structures have a base (such as the base of a triangle), the material making up the base of the structure may be different than the rest of the fill material situated in the structure. For example, the base of a triangular cross-sectional structure may be constructed of aluminum while the rest of the structure may be filled with a clear polymer having a lower index of refraction than that of the transparent film material.

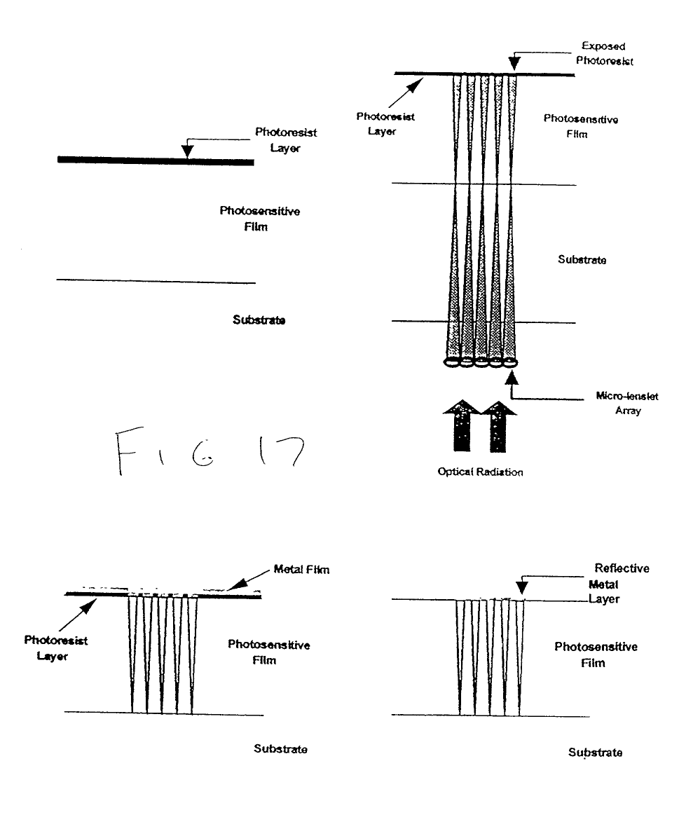

A second method of manufacturing the device according to the present invention includes two processes that are capable of producing the desired structures in a transparent photosensitive film. The desired structures are produced by changing the index of refraction in specific areas of the body of the transparent photosensitive film. As shown in FIG. 16, the first process includes forming a transparent photosensitive film on the surface of a substrate. The transparent photosensitive film may be constructed of any clear material that, when exposed to light, changes its optical properties. The photosensitive material should exhibit favorable optical and mechanical properties. In addition to a sufficient photo-induced refractive index change, a suitable set of “writing” wavelengths (typically in the ultraviolet), optical transparency, thin film formability, and mechanical behavior are of great importance. Such materials may be OLED's or organic polymers that have optimized mechanical behavior, or organic-inorganic hybrids that combine the chemical versatility of organic polymers, i.e. polysilanes, polygermanes, and/or their sol-gel hybrids. Other materials include organic polymer such as specially modified polyethylene, polycarbonate, polyvinylcinnamate, and polymethylmethacrylate. Other materials include the combination a transparent polymer matrix and a polymerable photo-reactive substance comprising a photopolymerizable monomer. The transparent polymer matrix may be selected from the group consisting of polyolefins, synthetic rubbers, polyvinyl chloride, polyester, polyamide, cellulose derivatives, polyvinyl alcohol, polyacrylates, polymethacrylates, polyurethane, polyurethane acrylate, and epoxy acrylate resin. The photo-reactive substance comprises a photo-reactive initiator which has a refractive index regulating activity and said film has a distribution of a refractive index. The photopolymerizable monomer may be selected from the group consisting of tri-bromophenoxyethyl acrylate and trifluoroethyl acrylate.

A thin layer of reflective material is then deposited on the surface of the photosensitive transparent film opposite the substrate. The preferred reflective material for the thin layer of reflective metal is a metal composite or other material with a high reflectivity such as aluminum, gold, silver, nickel, chrome, a dielectric or other metallic alloy with a reflectivity of 80% or greater. Preferably, the reflectivity of the material is 95% or greater. Predetermined regions of the reflective metal deposition are then removed by ablating the reflective material to expose the photosensitive film in the predetermined regions. These predetermined regions are then exposed to a light source to change the optical characteristics of the photosensitive film in the predetermined regions to alter the index of refraction of the photosensitive film in the predetermined regions to thereby form altered refractive index areas. The steps of ablating the reflective metal and changing the optical characteristics of the photosensitive are accomplished by a light source (that faces the metal reflective layer) that may produce ultraviolet light. The light source may comprise an optical radiation source that irradiates light, at a specific wavelength and of sufficient intensity, through a micro-lenslet array so as to ablate the reflective metal layer and change the optical characteristics of the photosensitive film. Preferably, the radiation source is an excimer laser.

The unchanged portions of the photosensitive film comprise unaltered refractive index areas (i.e., structures) having a lower index of refraction than the altered refractive index areas. Preferably, the unaltered refractive index areas are triangular cross-section structures each having a base, a height, and a pair of sidewalls each having an outside surface. The base is associated with the reflective metal layer and each sidewall is at an angle relative to said base. Preferably, the angle is between 76 degrees and less than 90 degrees. Preferably, the width of the base has a value of between about 2 and 200 microns. Preferably, the triangular cross-section structures have a height-to-base aspect ratio of between about 2 and 22. Preferably, each base of the triangular cross-section structures is separated by a distance having a value between about 1 micron and 100 microns. Preferably, the outside surface of the pair of sidewalls is planar, concave, convex, and pitted. Preferably, the triangular cross-section structures are parallel to each other.

As shown in FIG. 17, the second process also includes forming a photosensitive film on the surface of a substrate. The transparent photosensitive film may be constructed of the same materials as discussed above. A photoresist layer is then formed on the photosensitive film. Predetermined regions of the photosensitive film and the photoresist layer are then exposed to a light source (that faces the substrate) to change the optical characteristics of the photosensitive film in the predetermined regions and to alter the index of refraction of the photosensitive film in the predetermined regions to thereby form altered refractive index areas in the photosensitive film. The light source may comprise an optical radiation source that irradiates light, at a specific wavelength and of sufficient intensity, through a micro-lenslet array so as to ablate the reflective metal layer and change the optical characteristics of the photosensitive film. Preferably, the radiation source is an excimer laser. The exposed photoresist layer in the predetermined region is then removed using a suitable etchant that creates an opening to the photosensitive film. A thin layer of reflective material is then deposited in the openings previously occupied by the exposed photoresist layer. The preferred reflective material for the thin layer of reflective metal is a metal composite or other material with a high reflectivity such as aluminum, gold, silver, nickel, chrome, a dielectric or other metallic alloy with a reflectivity of 80% or greater. Preferably, the reflectivity of the material is 95% or greater. Finally, the residual photoresist layer is washed away and lifted off.

The unchanged portions of the photosensitive film comprise unaltered refractive index areas (i.e., structures) having a higher index of refraction than the altered refractive index areas. Preferably, the altered refractive index areas are triangular cross-section structures each having a base, a height, and a pair of sidewalls each having an outside surface. The base is associated with the reflective metal layer and each sidewall is at an angle relative to said base. Preferably, the angle is between 76 degrees and less than 90 degrees. Preferably, the width of the base has a value of between about 2 and 200 microns. Preferably, the triangular cross-section structures have a height-to-base aspect ratio of between about 2 and 22. Preferably, each base of the triangular cross-section structures is separated by a distance having a value between about 1 micron and 100 microns. Preferably, the outside surface of the pair of sidewalls is planar, concave, convex, and pitted. Preferably, the triangular cross-section structures are parallel to each other.

In other embodiments related to utilizing a photosensitive transparent material, discrete structures may be arranged in varying structures, heights, angles, or spacing and one or more of the discrete faces of a structure, including the triangular rows, may be concave, convex, and/or pitted. Additionally, micro-shapes (such as pyramids or cones) may be deposited on one side of the body of the element directly over the base of each structure, either as part of a deposition process, described above, or as an independent process, to further control the direction of reflected energy. In other embodiments, the indices of refraction may be different for each discrete structure such that various alternating patterns are produced across the body of the element to achieve specific effects. In other embodiments, a combination of structures created by filled indentations and altering the refractive index of a photosensitive material may be used to create various patterns across the body of the element. In one embodiment, a reflective material such as metal or any material with the equivalent of an infinite index of refraction may be inserted underneath the polymer-cladding layer (layer of lower index of refraction material) to reflect light exceeding the cladding's index of refraction critical angle. This will reflect light normally lost by reflecting light back into the wave-guide region. This technique may be used for all structure sizes defined above.

Another method of creating the structures of the present invention is by fabrication of the structures from some suitable material that will maintain integrity in the physical working environment, and suspending the structures by some suitable method. Suspension may be accomplished by the use of wire or some type of filament that forms a grid, but will depend on the specific application and will be apparent to one skilled in the art. This aspect of the invention is useful in solar applications, where the size of transflectors is not limited by the size requirements of non-emissive displays.

Another method to manufacture wave guiding structures is to directly locate the sturctures on top of a supporting surface such as glass or polymer. One preferred embodiment is an isosceles shaped wave guide structure made of metal or a highly reflective material resting on glass. The wave guide structures are laid on top of or deposited on the underlying supporting surface. Another preferred embodiment is where the supporting surface contains periodic shapes (grooved or projection) wherein a fluid containing the appropriate mating pieces is passed over the periodic shapes of the supporting surface such that the probability of creating the desired device is 100%. This can be accomplished as in biological systems by having a sufficient number of the mating pieces carried in the fluid in excess of the shapes on the supporting structure.

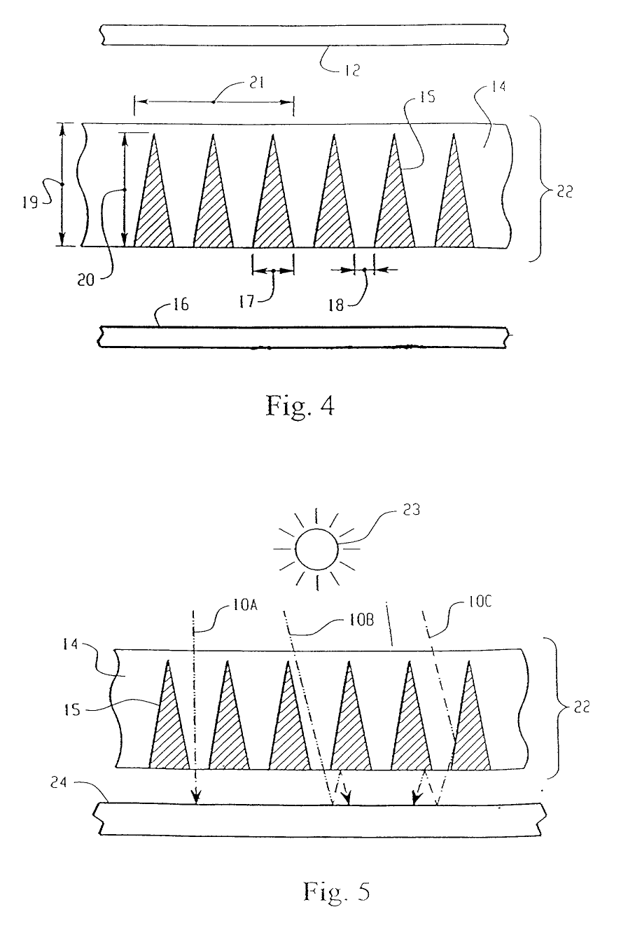

As shown in FIG. 4, a device according to the present invention can be utilized in an emissive-display application. Let 14 represent the transparent material, 15 represent the reflective indentations or objects, 12 represent the backlight assembly, and 16 represent the remainder of the non-emissive display system and the direction from which the display is viewed. Let:

17=r=half width of base of the groove, or object

2r=base of groove, or object

f=multiple of the half width of base of the groove

18=fr=spacing between indentations

19=Th=film thickness (based on the height of the groove, or object, and is determined by the nature of the transparent material)

K=multiple of the half-width of base of the groove

20=Kr=height of groove, or object

21=M=number of indentations per pixel (picture element) defined here as the smallest controllable area of the display

Also let

R_{M2}=reflectance of the reflective material to normally incident light

22 represents the invention as a whole

The mirror-like and funnel effects can be accomplished by using a combination of appropriate (1) shaping of the material comprising the film and (2) choice of materials with either different reflectivities, indices of refraction, composites, or a combination of the two. The light directing/funneling structures and/or microstructures include, but are not limited to indentations (intersecting or not), cones or other conic sections, multi-sided structures (regular or not) such as pyramids or tetrahedrons, all structures of the same or different sizes generally varied periodically and in which the reflectance, transmittance, and absorption of the film might have different values.

The first application of a device according to the present invention is related to uses in which light is to be directed without regard to dispersion upon transmission, in particular for use in solar collectors or any device in which radiated light is to be directed or collected as illustrated in FIG. 5. In this drawing light from the sun 23 enters the transparent material 14 as light ray 10A and is transmitted directly to an absorbing material 24. Light ray 10B passes through the transparent material 14 and is partially reflected by the absorbing material 24. Light ray 10C passes through the transparent material 14 and is redirected by the reflecting structure 15 to the absorbing material 24, is partially reflected by the absorbing material 24. In the first embodiment, the design is for maximum sum of transmissivity and reflectivity. Then maximum sunlight will be collected and retained within the specific device in which the film is a part. Therefore, for this embodiment, let R_{M2}=1.00; a perfectly reflecting material. Let f=0.1, the practical limit for manufacturability of the indentations. Choose values for r and f large enough to avoid diffraction and interference effects. For example, choose r=200μ so that the spacing between adjacent indentations at the base is 20μ, well above the longest wavelength of visible light. For a solar collector where multiple reflections during transmission are insignificant as long as perfectly reflecting material is used, R₁=2/(2+f)=0.952 and T₂=1.000. Thus, R₁+T₂=1.952, near the theoretical limit of 2.000. Thus, virtually all light energy entering the system will be trapped.

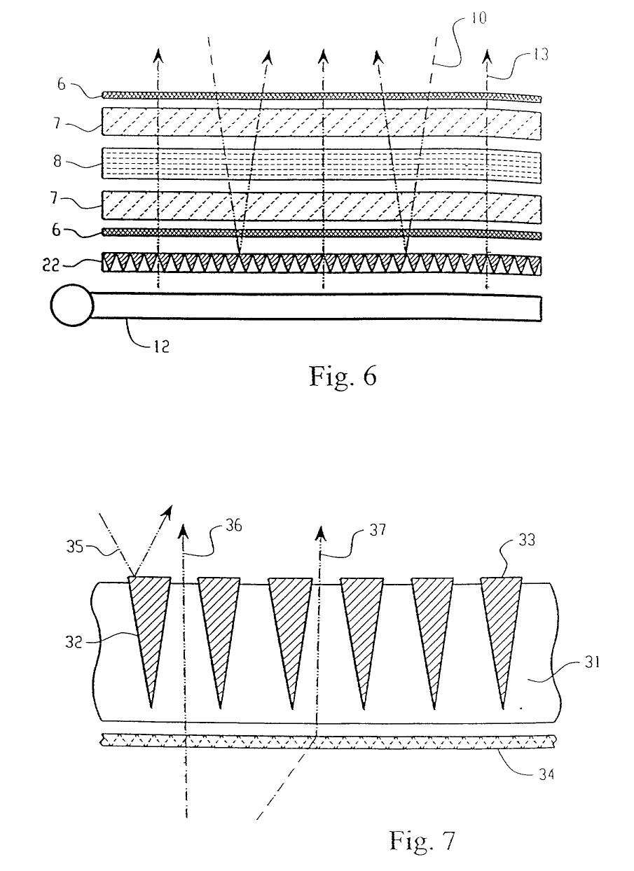

The second application of a device according to the present invention is related to uses with a non-emissive display system, such as a liquid crystal display (LCD), or other devices in which light is directed for the purpose of creating an image. Non-emissive display systems using the present invention will have a composition similar to that illustrated in FIG. 6. In this drawing, a typical non-emissive display system includes a stack comprising a backlight 12, a polarizer 6, a liquid crystal suspension 8, and another polarizer 6. On occasion, glass plates 7 may be layered in between each polarizer 6 and the liquid crystal suspension 8. The device according to the present invention will be preferably positioned in between the backlight 12 and the polarizer 6. In operation, ambient light 10 will pass through the various layers of polarizers 6, glass plates 7 (which may include color filters, common electrodes, TFT matrix, or other components), and liquid crystal suspension 8 and will be redirected by the reflective structures of the device 22 according to the present invention, back through the various layers 6 through 8, while at the same time artificial light rays 13 generated from backlight assembly 12 will pass through the transparent elements of the invention 22 may be attached to adjacent elements such as backlight assembly 12 or be installed as a separate layer in the display system.

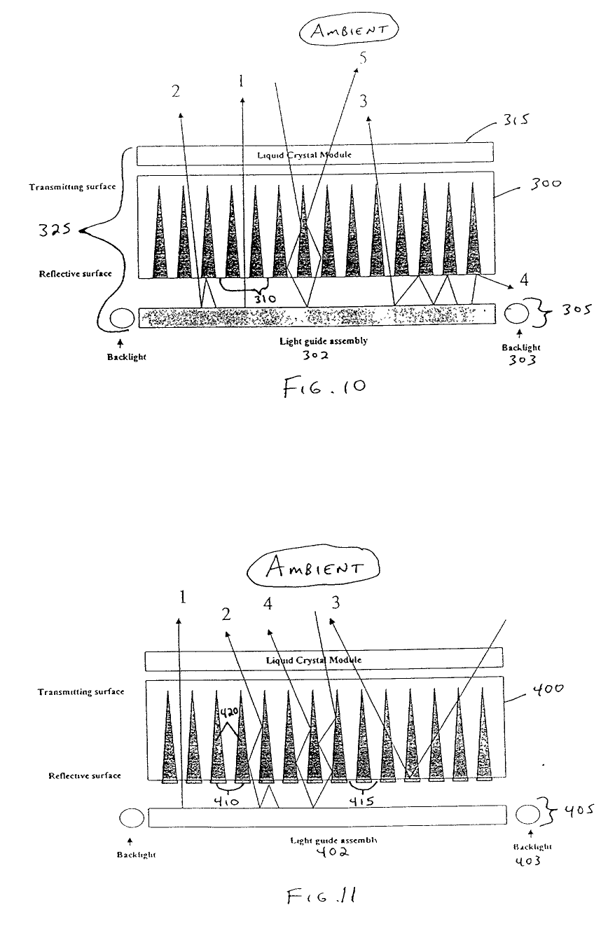

As shown in FIG. 10, the device 300 according to the present invention may be inserted between the backlight assembly 305 (i.e., the backlight 303 and the light guide assembly 302) and the liquid crystal module 315 where the reflective surface of the device 300 faces the backlight assembly 315 and the transmissive surface faces the liquid crystal module 315.

The reflective surface of the device 300 faces the backlight assembly 305, with light coming out of the backlight assembly 305 and passing through the openings 315 (Ray 1), to be processed by the liquid crystal module 315. Light not passing through the aperture 310, is reflected off the reflective surface of the device 300 and directed back to the light guide assembly 302, and the light guide assembly 302 reflects the light back towards aperture 310 (Ray 2), or once again, hitting the reflective surface of the device 300. The light is repeatedly reflected until it either passes through an aperture 310 (Ray 3), or is lost to the system by absorption or reflection (at large angles) (Ray 4). Ambient light may pass through the LCD stack 325, transmit through the device 300, reflect off the light guide assembly 302, and either pass through the apertures 310 in the device 300, or is reflected by the device 300 back to the light guide assembly 302 until light is eventually passed through the apertures in the device 300 (Ray 5), absorbed, or reflected (at angles where light is lost to the system). This is so except for cases where the ambient light reflects off the rear of the device 300 reflecting surface or off the light guide assembly 302 whereby the light then passes through the liquid crystal module 315.

Alternatively, the device according to the present invention may be inserted between the backlight assembly and the liquid crystal module where the reflective surface of the device faces the liquid crystal module and the transmissive surface of the device faces the backlight assembly. It is important to note that the device, in either above embodiment, may be a component of the backlight assembly, or may be attached to a component of the remainder of the display system.

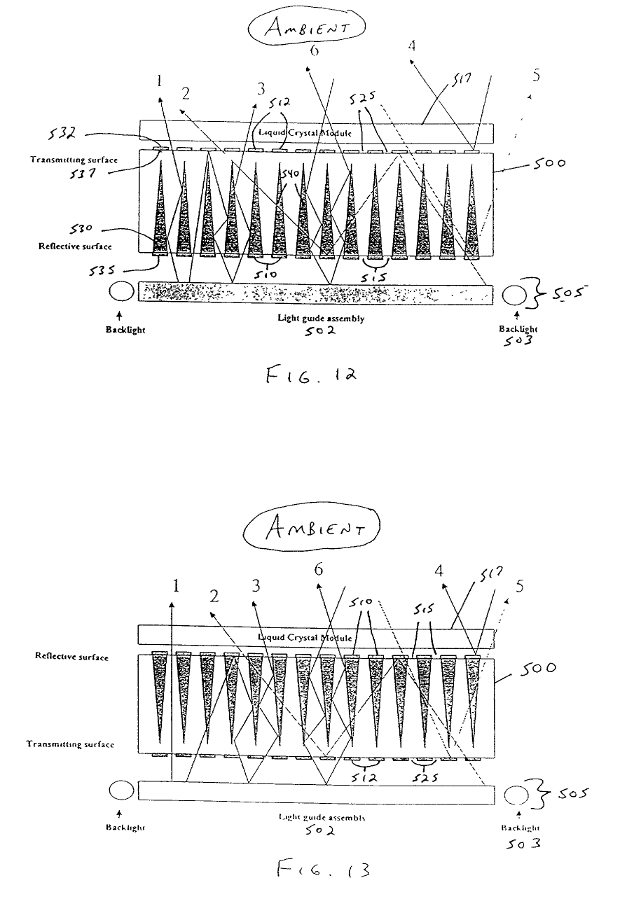

In another embodiment, raised reflective structures 410 are applied to the surface of the device 400 facing the backlight assembly 405 as shown in FIG. 11. The reflective structures 405 are positioned in association with the base of the structures 420 within the device 400 and spaces apart, defining apertures 415 to allow to pass between the reflective structures 410 through the apertures 415. The apertures 415 may be a hole, window, slit or other opening means. The reflective structures 410 reflect both backlight 403 generated light and ambient light sources. The reflective structures 410 have surfaces that are flat, convex, concave, rippled, textured, dimpled or any combination thereof. The reflective structures 410 reflect light from both the reflective and transmissive surfaces of the device 400. Backlight 403 generated light either passes through an aperture (Ray 1) or is allowed to be reflected back towards the light guide assembly 402. The backlight side (the side facing the backlight assembly) of the reflective structures 410 on the surface facing the backlight wave guide assembly reflect light until transmitted to the liquid crystal module through an aperture, or eventually lost due to absorption, or large reflected angles (Ray 2). Ambient light sources either reflect directly from the side of the reflective structures facing the liquid crystal module where ambient light exceeds the critical angle of the polymers wave guide (Ray 3) or from the light guide assembly 402 after being guided through an aperture 415 (Ray 4). Light passing through the aperture is then indistinguishable from a transmissive processing prospective from light originating from the backlight.

In another embodiment and as shown in FIG. 12, reflective structures 510 are positioned on the surface of the device 500 facing the backlight assembly 505 and reflective structures 512 are positioned on the surface facing the ambient source. The reflective structures 510 reflect both backlight 503 generated light and ambient light sources. The reflective structures 510 have surfaces that are flat, convex, concave, rippled, textured, dimpled or any construction thereof. The reflective structures 510, 512 reflect light from both the top surface 530, 532 and bottom surface 535, 537 of the reflective structures 510, 512 respectively. Backlight 503 generated light either passes through an aperture 515 in the reflective surface of the device 500, or is reflected back towards the light guide assembly 502. Light passing through a reflective surface 515 aperture either passes directly through a transmissive surface 525 aperture being guided by a wave guiding structure 540 (Ray 1), or is reflected back towards the reflective surface reflective structures 510, eventually reflecting the light back to the top until it exits through a transmissive surface 525 aperture (Ray 2), a reflective surface aperture 515, absorbed, or reflected at a large angle where the light is lost to the system. Backlight 303 generated light is allowed to be reflected back towards the light guide assembly 502, and eventually passed through a transmitting surface 525 aperture (Ray 3). Ambient light sources either reflect directly from the transmissive surface reflective structures 512 (Ray 4) or from the reflective surface reflective structures 510 after passing through the transmitting surface aperture 525 (Ray 5), or passing through both apertures 515, 525 and being reflected by the light guide assembly 502 and then again back towards a reflective surface aperture 515 (Ray 6). Ambient light passing through the transmitting surface apertures 525, and being reflected by the system until once again clearing a transmitting surface aperture 525 is then indistinguishable from a transmissive processing prospective from light originating from the backlight 505.

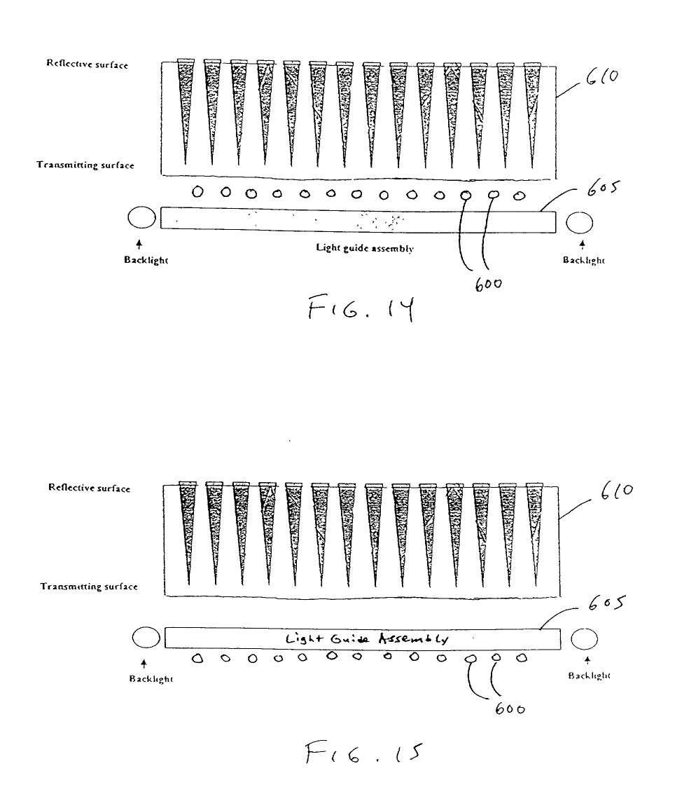

In another embodiment as shown in FIG. 13, the device 500 is inserted between the liquid crystal module 517 and the backlight assembly 505 such that the transmitting surface faces the backlight assembly 505 and the reflective surface faces the liquid crystal module 517. Essentially, this embodiment is the same as the embodiment of FIG. 12 in structure and function except that the device 500 is inverted 180°.

In another embodiment, the device according to the present invention can be positioned within the liquid crystal module itself in three configurations: (1) at the back (surface) of the rear glass of the liquid crystal module and in front of the polarizer, (2) at the back (surface) of the rear glass of the liquid crystal module and behind the polarizer, or (3) inside the rear glass of the liquid crystal module at the pixel level. For a two-polarizer liquid crystal display system, only the second configuration is possible in order for the display to process the light. For a single polarizer liquid crystal display system, all three configurations are possible as the display can process the light.

A process for manufacturing an liquid crystal module is disclosed whereby the device according to the present invention is a foil or a component within or adhered to the existing LCD stack. “Within or adhered to” includes: (1) at the back (surface) of the rear glass of the liquid crystal module and in front of the polarizer, (2) at the back (surface) of the rear glass of the liquid crystal module and behind the polarizer, or (3) inside the rear glass of the liquid crystal module at the pixel level. The LCD manufacturing process can be done on a roll-to-roll and/or assembled-by-layer basis for any of the embodiments described and the device is an integral part of the stack. The layers of the LCD stack are produced and/or assembled on a roll-to-roll basis, and the device is inherent as a part of the glass, pixel, collimator, or polarizer. The device construction is based on layering functional components onto a liquid crystal module substrate, allowing the device to be constructed as part of the overall liquid crystal module manufacturing process.

Preferably, the emissive display system would include a means for collimating light such that the majority of light emerges perpendicular to the device according to the present invention. Also, the emissive display system would include a means for polarizing light. In any case, the collimating and/or polarizing material may be attached to the reflective or transmissive side of the device. The highly transmissive side of the device according to the present invention faces the backlight system and the highly reflective side faces the viewer, while in another embodiment the highly transmissive surface of the device according to the present invention faces the liquid crystal module and the highly reflective surface faces the backlight assembly. The collimating and/or polarizing material can be attached to the entire reflective surface of the device or to just the apertures between the wave guide structures of the device. The collimating and/or polarizing materials may be an integrated design element and part of the manufactured product, not just adhered or fixed to either surface of the device. If collimating film is required to optimize performance for the liquid crystal module after emergence from the device (on its reflective side), the collimating film may either cover the entire area of the device or simply cover the apertures from which the light emerges. The collimating film may cover the full area of the display or at least a portion thereof. The indentations or objects may be arranged at any angle to the edge of the display, from parallel to oblique. Alternatively, a polymer having a higher index of refraction than the transparent film material (body) could be used to optimize the performance. By just covering the apertures, the impact on the reflective portions of the device would be minimized.

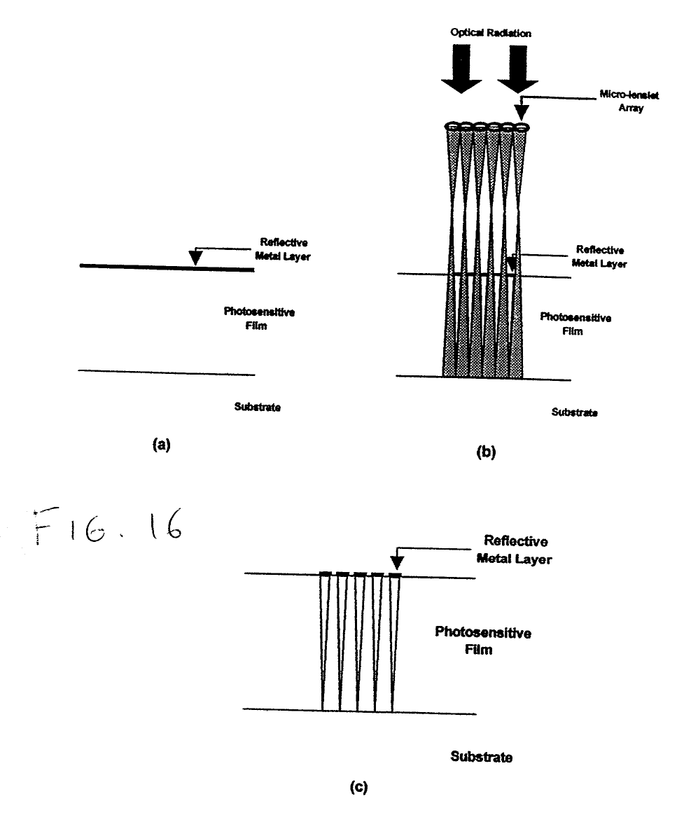

Another way to collimate light is to include lens lets within the liquid crystal display system. The location could be either an integral part of the device or separate from it. As shown in FIG. 14, the location of the lens lets 600 may be directly above the light guide assembly 605 of the backlight and underneath the device 610. Alternatively, as shown in FIG. 15, the location of the lens lets 600 may be directly below the light guide assembly 605 of the backlight.

To design an efficient liquid crystal display system,

Let

W_{T}=width of the display

m=number of indentations per pixel (picture element) defined here as the smallest controllable area of the display

F_{W}=format of display in horizontal direction (number of distinct elements, where each element has a red, green, and blue pixel)

Then r=W_{T}/[3 F_{W} m(2+f)] for a color liquid crystal display. To illustrate the method of design, let W_{T}=246 mm and F_{W}=800 represent the typical values for a vintage 1996/97 color liquid crystal display design. Also, let m=3 to eliminate the necessity of alignment of the film with the pixels of the display during the display assembly process. Additionally, m may be increased or decreased as necessary to eliminate visible non-uniformities in the light distribution, such as banding, which may be created by the film.

For the designs shown for the second application, let f=0.5. This minimizes the redirection of light, preserving the original direction of the transmitted light. For this value of f, 20% of parallel light from the backlight system will be transmitted without reflection, 40% will be transmitted with one redirection from the reflecting indentations or objects, and 40% will be transmitted after two redirections from the reflecting indentations or objects. In this instance r can be calculated using the equation r=W_{T}/[3 F_{W} m(2+f)] to be 13.7Φ with a spacing fr (spacing between indentations) of 6.9μ. The reflectance R₁ and transmittance T₂ can be computed if R_{M2} (normal reflectance of the material) is known. Note two design examples:

1. Let R_{M2}=1, then R₁=2/(2+f)=0.8. and T₂=1.0, resulting in R₁+T₂=1.8.

2. Let R_{M2}=0.86, then R₁=2 R_{M2}/(2+f)=0.688. and T₂=0.840, resulting in R₁+T₂=10.528.

Both designs show the significant improvement available from use of the technology according to the present invention in the place of existing transflector technology.

In the preferred embodiment for non-emissive displays, the element should not exceed 100 mils thickness. The body of the element should have a transmissive co-efficient of >97%. The apex (tip) of each of the structures penetrates into the body of the element a percentage of the total thickness between 10%-100%. Each structure may have a fixed apex angle of between 2.6°-9.5°, with a height to base ratio of between 2:1-22:1. In another embodiment, the structure will have a fixed apex angle of between 3.0°-7.0°, with an altitude to base ratio of between 8:1-18:1. In either embodiment, the height to base ratio may be as low as 2:1. Lower aspect ratio structures can be used to manage light effectively by increasing the index of refraction difference between the transmitting region and the cladding region (that is, between the high index of refraction region and the low index of refraction region) or by using metal of sufficient reflectivity in the cladding region as a reflecting surface. Model calculations indicate that an aspect ratio of ˜4 would give a transmissivity of ˜0.4 for an index of refraction difference of ˜0.2. In general, the specific aspect ratio required to deliver a fixed performance level (of transmissivity) decreases as the difference of index of refraction between the regions increases. The aspect ratio affects how light will be distributed upon exiting the light management system, and is a factor in determining how many reflections of the incident light can occur relative to a specific incident angle. Using a method where light is reflected internally by using two different polymer materials having a different index of refraction, the critical angle can be calculated. If the incident angle from the transmitting region exceeds the polymer boundary critical angle, light will not be reflected, but will penetrate the second polymer and thus be lost to the system. The smaller the aspect ratio, the easier is the manufacturing process. However, the cumulative deflection for a given angle of light incident on the lens is larger so that the acceptance angle is smaller. Light, which previously passed through the system, will instead pass into the cladding (second) polymer, thus decreasing the effective transmission. By increasing the difference in the index of refraction between the two polymers, we can decrease the angle at which light will be absorbed, thus increasing the effective transmission.

This results in the walls of the structure being at an angle relative to the base of between about 83 degrees to less than 90 degrees. In conjunction with collimating film, the angle of the walls of the structure relative to the base is between about 76 degrees and less than 90 degrees and the aspect ratio may be as low as 2:1. The base of the shape is parallel to a surface of the element and has a base width of between 2.0μ-200.0μ. In another embodiment, the base width may be between 2.0μ-50.0μ. Whether the shape is created with fill material or through an optical process, the base of each structure needs to be reflective. This can be achieved either through a fill process, through a deposition/photoresist process, or other methods such as the use of overlays. Where the transmission of light energy (from the direction of the apex of the structures) and the reflection of infrared energy is required, a reflective coating may be provided at the base of the structure that acts as a reflector of infrared (an insulator). This reflective coating may be constructed of a ceramic material or any other material with similar insulation properties. Thus, the base of the triangular cross-section structure may be constructed of ceramic to provide infrared reflection, while the rest of the triangular cross-section structure may be constructed of a metal to provide the necessary reflection of transmitted energy. In general, the reflective coating at the base of the structure can be chosen to reflect any particular region of the electromagnetic spectrum including visible light spectrum. For example, in a solar application, the transmissive part of the system would be for the light energy and the reflective part for the infrared energy. In this example, the apex of the structure faces the sun.

The triangular row structures are periodically repeated with a fixed spacing between the apex of each triangle of between 3.0μ-300.0μ and the spacing between the base of each adjacent isosceles triangle is between 1.0μ-100.0μ. In another embodiment, the spacing between the apex may be between 3.0μ-70.0μ and the spacing between the bases may be between 1.0μ-20.0μ. In the preferred embodiment, a collimating element is attached to the element adjacent to the transmitting side of the device. The dimensions described in the preferred embodiment should not be interpreted as limitations since other applications may require, or allow, variations on the above specifications.

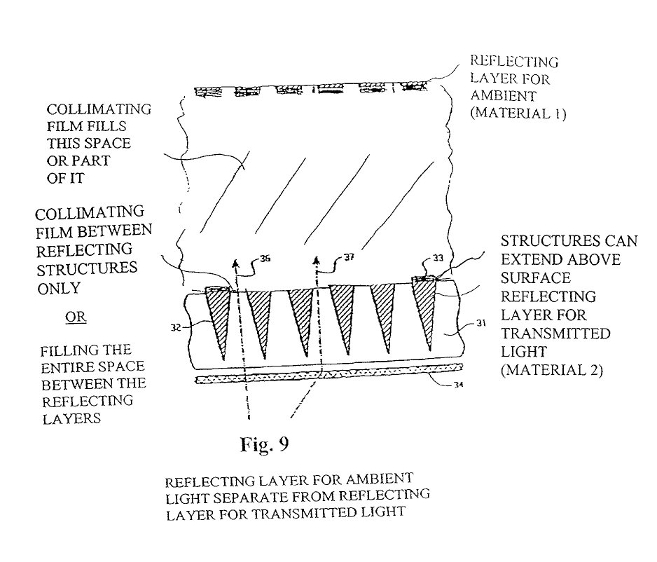

As described above, the reflective material may be coated on the transparent body, be part of the fill for grooves in the body, or be the base of the refracting structure physically separate from but attached to the transparent body as shown in FIG. 9. To enhance the performance of the device according to the present invention, the reflective layer and its apertures may be separated from the layer containing the wave-guide optics wherein the space between the reflective layer and the wave-guide layer is defined as a void. There is greater efficiency in the reflective layer by locating it on the interior side of a LCD rear glass (or polymer) so that the reflecting surface is only microns from the color filters. The wave-guide layer is located adjacent to, or attached to, the backlight. When the structures in the wave-guide layer are triangular in cross-section, the side of the wave-guide layer having the apex of the triangles faces the backlight, while the apertures of the wave-guide is aligned to the apertures of the reflecting layer. This allows the highest degree of transmission through the reflective layer. A piece of glass or polymer may be provided to fill the void. Preferably, a piece of collimating film may be provided before and/or after the wave-guide layer to direct the device-generated light (i.e., backlight) in a maximally efficient manner to the aperture of the reflecting layer.

Another embodiment is shown in FIG. 7. Let 31 represent the transparent material (body of the element), 32 represent the reflective/refractive shapes, 33 represent a reflective material (where no fill, gas, vacuum, or a change of indices of refraction are used to create structures), and 34 represents a collimating element attached to the device. Light ray 35 strikes the base of a shape 32 and is redirected away from the element (reflected). Light ray 36 enters the element from a transmissive energy source (not shown), passes through the collimator 34 without redirection, passes through the body of the element 31 without striking any shaped structures 32 and exits the reflecting side of the element without redirection. Light ray 37 enters the collimator from a transmissive energy source (not shown) at an incident angle greater than 10 degrees and is redirected by the collimator 34 to less than 10 degrees. Light ray 37 enters the body of the element 31 and passes through without being redirected.

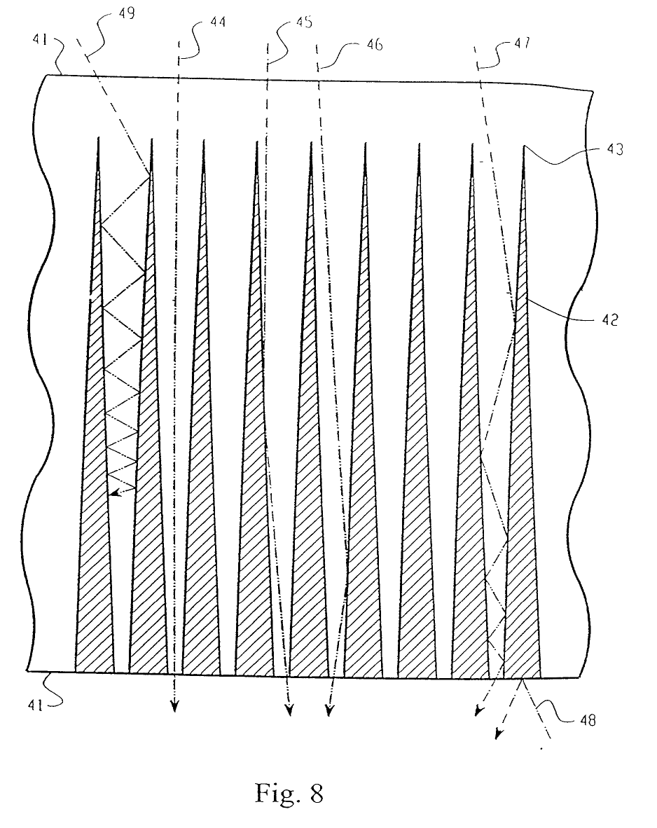

FIG. 8 represents a cross-section of the device according to the present invention, where 41 represents the boundary edge of the element. Structure 43 extends into the element a percentage of the total element thickness. Let the apex (tip) of structure 43 have an angle of 4 degrees. Additionally, let the apex of structure 43 face one light source (not shown) while the base of the structure 43 faces another light source (not shown). Light ray 44 enters the element perpendicular to the plane of the element and passes through the element without striking a shaped structure 43 and exits the element without redirection. Light ray 45 enters the element perpendicular to the plane of the element and strikes the midpoint of a structure 43 and is minimally redirected (4 degrees relative to perpendicular to the plane of the element) such that it exits the element without striking an adjacent structure 43. Light ray 46 enters the element perpendicular to the plane of the element and strikes a structure 43 near the apex (tip) and is minimally redirected (4 degrees relative to perpendicular to the plane of the element) such that it strikes an adjacent structure near the base of the structure (16.6% of the height of the structure) and is again minimally redirected (as above) such that the total redirection of light ray 46 is 8 degrees from the perpendicular to the plane of the element upon exiting the element. Light ray 47 enters the element at an angle greater than 10 degrees of perpendicular to the plane of the element and strikes a structure 43 above the midpoint and is minimally redirected (4 degrees relative to perpendicular to the plane of the element). Due to the increased angle of entry of light ray 47, multiple redirections occur before light ray 47 exits the element. In this example, seven redirections are necessary for light ray 47 to exit the element—the cumulative redirection is 28 degrees. Light ray 48 is reflected by a structure 43 at an angle equal to the angle of incidence. Light ray 49 enters the element at a steep angle relative to the perpendicular to the plane and strikes a structure 43 near the apex (tip), due to the cumulative redirection light ray 49 cannot exit the opposite side of the element.

FIG. 8 is configured with structures 43 at an aspect ratio of 14.3, a spacing between structures 43 of 25% of the base width, and structures evenly spaced across the body of the element. Such an element will produce a transmissivity of 94% of light rays entering the element perpendicular to the plane from the side closest to the apex (tip) of structures 43 (transmissive side). The element described above will provide the additional benefit of reflecting 76% of light striking the element from the opposite direction. In this example, 20% of light entering from the transmissive side will pass through the element without redirection, 40% will pass through with a single redirection (4 degrees relative to perpendicular to the plane of the element) and 40% of the light will have two redirections (8 degrees relative to perpendicular to the plane of the element). This example provides an R+T of 1.70. The combination of aspect-ratio and spacing of structures described above are intended to illustrate the effects of configuration of the element and are not intended to be limiting.

Another embodiment of the invention is related to uses in which light is to be directed or focused upon transmission, in particular for use in building materials where light from the sun is used to illuminate an interior area or augment artificial lighting. In this embodiment the indentations, or objects, may be angled such that the base of the indentation, or object is not parallel or coincident with the boundary of the transparent material. This embodiment will allow the light to be directed at a given angle to the transparent material independent of the angle of the light source.

The device according to the present invention is independent of any specific system, but will typically be included as one of several elements incorporated within a system. The device provides optimized reflection of energy in one direction while simultaneously optimizing the transmission of energy in the opposite direction. By significantly increasing the surface area of the reflecting/refracting structures in one direction (the apex of the structure) with respect to the base of the structure, the amount of energy that can reflected in one direction can be decoupled from the amount of energy transmitted in the opposite direction.

The term “light”, as used in the present application, encompasses electromagnetic radiation with wavelengths corresponding to visible through infrared. The present invention's apparatus is, however, applicable to any electromagnetic radiation that is capable of being reflected or refracted, subject to the ability to create structures of a size and a material to do so. Specifically, the present invention can find applicability in the radio, radar, microwave, infrared, visible, ultraviolet, x-ray and gamma forms of radiation.

Another application utilizing a device of the present invention is solar radiation collection. One of the more common methods of collecting solar radiation is by the use of mirrors to reflect radiation from the sun onto a complex of pipes. The pipe complex consists of a first pipe carrying the liquid to be heated, surrounded by a second pipe. The space between the two pipes will typically be evacuated to decrease the amount of convection and conduction loss. By mounting the present invention's structure within this space between the pipes, the majority of solar radiation from the mirror will be trapped and reflected back onto the pipe to be heated, thus increasing overall efficiency. In most situations, the heated pipe will also be emitting radiation, which will also be trapped and reflected back. Thus, solar radiation passes through the transflector, while radiation not initially absorbed by the solar collector, combined with any radiation being emitted from the solar collector due to it's temperature, is reflected back to the solar collector. In this embodiment, the vacuum is the transparent material associated with the structure.

In such solar applications, the height of the structure will only be dependent on the spacing between the pipes, and the base of the structure may be large as compared to the use in non-emissive displays. The width of the base may be 3500Φ or larger, although the smaller size structures will also be applicable to this use. The multitude of structures will preferably be bent around at least a portion of the pipe to improve both the gathering and reflection of radiation.

In yet another application, the present invention may be utilized where radar and sound waves can be absorbed or directed away from a collector (detector). Structures may be made from radar and or sound absorbing materials. The aspect ratio of the structures provide the capability to internally reflect the waves, eventually completely absorbing them or redirecting them at an angle undetectable by a collector (either electronic or living). To accomplish this purpose, a structure such as an isosceles triangle angled to the surface is used, the angle being greater than the acceptance angle, so that the energy emerging from the structure is limited. Other designs can cause the emerging energy to diffuse (scatter). Thus, the system can be made to act in several ways: first as a very good absorber, second as a very good scattering or diffusing device, and third as a combination of both. Applications include absorption or redirection of radar waves and sound waves (for example, in a concert hall).

While specific embodiments according to the present invention have been described and illustrated herein, it will be apparent to those skilled in the art that variations and modifications are possible, such alterations shall be understood to be within the broad spirit and principle of the present invention which shall be limited solely by the scope of the claims appended hereto.

Having thus defined the invention, what is claimed is:

1. A device having transmissive and reflective properties produced by the process comprising the steps of:
forming a transparent photosensitive film on the surface of a substrate;
forming a reflective metal layer on the photosensitive film;
ablating the reflective metal layer in a predetermined region to expose the photosensitive film in the predetermined region; and
changing the optical characteristics of the photosensitive film in the predetermined region to alter the index of refraction of the photosensitive film in the predetermined region to thereby form an altered refractive index area.

2. The device of claim 1, wherein an unchanged portion of the photosensitive film comprises an unaltered refractive index area.

3. The device of claim 2, wherein the altered refractive index structure has a higher index of refraction than the unaltered refractive index area.

4. The device of claim 3, wherein the ablating and changing steps occur in a plurality of predetermined regions thereby forming a plurality of altered refractive index areas.

5. The device of claim 4, wherein the unchanged portion of the photosensitive film comprises a plurality of unaltered refractive index areas.

6. The device of claim 5, wherein the unaltered refractive index areas are triangular cross-section structures each having a base, a height, and a pair of sidewalls each having an outside surface, the base is associated with said reflective metal layer, each sidewall is at an angle relative to said base.

7. The device of claim 1, wherein said reflective metal layer has a desired reflectivity percentage.

8. A device having transmissive and reflective properties produced by the process comprising the steps of:
forming a photosensitive film on the surface of a substrate;
forming a photoresist layer on the photosensitive film;
changing the optical characteristics of the photosensitive film in a predetermined region by exposing the predetermined region of the film to a light source to alter the index of refraction of the film in the predetermined region to thereby form an altered refractive index area and to expose the photoresist layer in the predetermined region to the light source;
removing the exposed photoresist layer in the predetermined region using a suitable etchant creating an opening;
depositing a reflective metal layer in the opening previously occupied by the exposed photoresist layer; and
removing the remaining photoresist layer.

9. The device of claim 8, wherein the light source is facing the substrate.

10. The device of claim 9, wherein an unchanged portion of the photosensitive film comprises an unaltered refractive index area.

11. The device of claim 10, wherein the altered refractive index area has a lower index of refraction than the unaltered refractive index area.

12. The device of claim 11, wherein the changing step occurs in a plurality of predetermined regions thereby forming a plurality of altered refractive index areas.

13. The device of claim 12, wherein the unchanged portion of the photosensitive film comprises a plurality of unaltered refractive index areas.

14. The device of claim 13, wherein the unaltered refractive index areas are triangular cross-section structures each having a base, a height, and a pair of sidewalls, the base is associated with said reflective metal layer, each sidewall is at an angle relative to said base.

15. The device of claim 1, wherein said reflective metal layer has a desired reflectivity percentage.

16. A method of making a device having transmissive and reflective properties comprising:
providing a transparent material film having a first and second surface, said transparent material capable of minimizing absorption and redirecting energy, wherein energy arriving from a first direction is permitted to enter said first surface and exit said second surface;
forming a plurality of indentations in said film, said plurality of indentations having an index of refraction different from that of said transparent material, wherein light arriving from a second direction, opposite said first direction, is reflected back toward said second direction.

17. The method of claim 16, wherein the sum of the percentage of light being transmitted relative to the amount of light coming from said first direction and the percentage of light being reflected relative to the amount of light coming from said second direction is greater than 100 percent.

18. The method of claim 17, wherein each of said indentations includes a reflective structure which reflects a portion of the light arriving from said first direction through said second surface.

19. The method of claim 18, wherein each of said plurality of reflective structures has a base parallel to said second surface, and a first and second sidewall situated at an angle to said second surface and communicating with said base, said angle sufficient enough to reflect light striking said plurality of reflective structures from said first direction through said second surface.

20. The method of claim 19, wherein said plurality of reflective structures are spaced apart from each other permitting light to enter said first surface and be transmitted out said second surface, and reflecting only a small portion of light entering said first surface while permitting a larger portion of light to transmit through said opposing surface.

21. A device having transmissive and reflective properties comprising:
a transparent material having a first surface and an opposed, second surface, said transparent material permitting light arriving from a first direction to enter said first surface, transmit through said transparent material, and exit said second surface; and
means for reflecting light arriving from a second direction, said second direction being opposite said first direction, wherein the sum of the percentage of light being transmitted relative to the amount of light coming from said first direction and the percentage of light being reflected relative to the amount of light coming from said second direction, is greater than 100 percent.

22. The device of claim 21, wherein said means for reflecting light arriving from said second direction comprises a structure having a reflective base parallel to said second surface wherein a percentage of light traveling from said second direction is reflected back toward said second direction by said reflective base.

23. The device of claim 22, wherein said means for reflecting light arriving from said second direction further comprises a pair of reflective sidewalls extending at an angle from said reflective base and joining toward said first surface, wherein light travelling from said first direction may strike said reflective sidewalls and exit said second surface.
